(19) United States
(12) Patent Application Publication
(10) Pub. No.: US 2026/0322425 A1
(43) Pub. Date: Oct. 15, 2026

(54) BEAM TRACKING FOR REFLECTOR-BASED COMMUNICATION

(71) Applicant: QUALCOMM Incorporated, San Diego, CA (US)

(72) Inventors: Idan Michael HORN, Hod Hasharon (IL); Yehonatan DALLAL, Kfar Saba (IL); Shay LANDIS, Hod Hasharon (IL); Amit BAR-OR TILLINGER, Tel-Aviv (IL)

(21) Appl. No.: 19/117,376

(22) PCT Filed: Oct. 11, 2023
(86) PCT No.: PCT/US2023/076630

§ 371 Date: Mar. 31, 2025

(30) Foreign Application Priority Data
Nov. 20, 2022 (IL) 298386

(51) Int. Cl. H04B 7/04; H04B 7/06

(52) U.S. Cl. CPC H04B 7/04013; H04B 7/06952

(57) ABSTRACT

A method for wireless communication at a wireless communication device includes receiving, from a network node at a reflector device of a group of reflector devices associated with the wireless communication device, a first beam associated with a first beam direction. The method also includes transmitting, to the network node via the reflector device based on receiving the first beam, a first message including a first beam tracking report that includes one or more first parameters associated with a second beam direction corresponding to a predicted position of the wireless communication device at a future time based on tracking motion of the wireless communication device. The method further includes receiving, from the network node based on transmitting the first message, a second beam based on the one or more first parameters.

### CROSS-REFERENCE TO RELATED APPLICATION

The present applications claims the benefit of Israel Patent Application No. 298386, filed on Nov. 20, 2022, and titled “BEAM TRACKING FOR REFLECTOR-BASED COMMUNICATION,” the disclosure of which is expressly incorporated by reference in its entirety.

### FIELD OF THE DISCLOSURE

The present disclosure relates generally to wireless communications, and more specifically to beam tracking for reflector-based communication.

### BACKGROUND

Wireless communications systems are widely deployed to provide various telecommunications services such as telephony, video, data, messaging, and broadcasts. Typical wireless communications systems may employ multiple-access technologies capable of supporting communications with multiple users by sharing available system resources (for example, bandwidth, transmit power, or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and long term evolution (LTE). LTE/LTE-Advanced is a set of enhancements to the universal mobile telecommunications system (UMTS) mobile standard promulgated by the Third Generation Partnership Project (3GPP). Narrowband (NB)-Internet of things (IoT) and enhanced machine-type communications (eMTC) are a set of enhancements to LTE for machine type communications.

A wireless communications network may include a number of base stations (BSs) that can support communications for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail, a BS may be referred to as a Node B, an evolved Node B (eNB), a gNB, an access point (AP), a radio head, a transmit and receive point (TRP), a new radio (NR) BS, a 5G Node B, or a 6G Node B.

The above multiple access technologies have been adopted in various telecommunications standards to provide a common protocol that enables different user equipment to communicate on a municipal, national, regional, and even global level. New radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM or SC-FDM (for example, also known as discrete Fourier transform spread OFDM (DFT-s-OFDM)) on the uplink (UL), as well as supporting beamforming, multiple-input multiple-output (MIMO) antenna technology, and carrier aggregation.

A wireless communication device, such as a UE or a reconfigurable intelligent surface (RIS), may be equipped or integrated with a set of reflector devices, such as modulated retro reflectors (MRRs) or smart repeaters. In some examples, the set of reflector devices may be used particularly for short range communications associated with high throughput and low latency. In some examples, a reflector device of the set of reflector devices may receive, from a network node, one or more signals (for example, short range signals) and reflect the one or more received signals to the network node to establish a communication link. In some such examples, after establishing the communication link, the network node may keep track of a best beam direction to maintain the communication link while satisfying quality of service (QoS) requirements. In some examples, the QoS requirements may include one or both of a throughput requirement or a latency requirement.

### SUMMARY

In one aspect of the present disclosure, a method for wireless communication includes receiving, from a network node at a reflector device of a group of reflector devices associated with the wireless communication device, a first beam associated with a first beam direction. The method further includes transmitting, to the network node via the reflector device based on receiving the first beam, a first message including a first beam tracking report that includes one or more first parameters associated with a second beam direction corresponding to a predicted position of the wireless communication device at a future time based on tracking motion of the wireless communication device. The method still further includes receiving, from the network node based on transmitting the first message, a second beam based on the one or more first parameters.

Another aspect of the present disclosure is directed to an apparatus including means for receiving, from a network node at a reflector device of a group of reflector devices associated with the wireless communication device, a first beam associated with a first beam direction. The apparatus further includes means for transmitting, to the network node via the reflector device based on receiving the first beam, a first message including a first beam tracking report that includes one or more first parameters associated with a second beam direction corresponding to a predicted position of the wireless communication device at a future time based on tracking motion the wireless communication device. The apparatus still further includes means for receiving, from the network node based on transmitting the first message, a second beam based on the one or more first parameters.

In another aspect of the present disclosure, a non-transitory computer-readable medium with non-transitory program code recorded thereon is disclosed. The program code is executed by a processor and includes program code to receive, from a network node at a reflector device of a group of reflector devices associated with the wireless communication device, a first beam associated with a first beam direction. The program code further includes program code to transmit, to the network node via the reflector device based on receiving the first beam, a first message including a first beam tracking report that includes one or more first parameters associated with a second beam direction corresponding to a predicted position of the wireless communication device at a future time based on tracking motion of the wireless communication device. The program code still further includes program code to receive, from the network node based on transmitting the first message, a second beam based on the one or more first parameters.

Another aspect of the present disclosure is directed to an apparatus including a processor, and a memory coupled with the processor and storing instructions operable, when executed by the processor, to cause the apparatus to receive, from a network node at a reflector device of a group of reflector devices associated with the wireless communication device, a first beam associated with a first beam direction. Execution of the instructions also cause the apparatus to transmit, to the network node via the reflector device based on receiving the first beam, a first message including a first beam tracking report that includes one or more first parameters associated with a second beam direction corresponding to a predicted position of the wireless communication device at a future time based on tracking motion of the wireless communication device. Execution of the instructions further cause the apparatus to receive, from the network node based on transmitting the first message, a second beam based on the one or more first parameters.

In one aspect of the present disclosure, a method for wireless communication includes transmitting, to a wireless communication device including a group of reflector devices, a first beam associated with a first beam direction. The method further includes receiving, from one reflector device of the group of reflector devices based on transmitting the first beam, a first message including a first beam tracking report that includes one or more first parameters associated with a second beam direction corresponding to a predicted position of the wireless communication device at a future time based on a motion and a speed of the wireless communication device. The method still further includes transmitting, to the wireless communication device, a second beam associated with the second beam direction based on the one or more first parameters.

Another aspect of the present disclosure is directed to an apparatus including means for transmitting, to a wireless communication device including a group of reflector devices, a first beam associated with a first beam direction. The apparatus further includes means for receiving, from one reflector device of the group of reflector devices based on transmitting the first beam, a first message including a first beam tracking report that includes one or more first parameters associated with a second beam direction corresponding to a predicted position of the wireless communication device at a future time based on a motion and a speed of the wireless communication device. The apparatus still further includes means for transmitting, to the wireless communication device, a second beam associated with the second beam direction based on the one or more first parameters.

In another aspect of the present disclosure, a non-transitory computer-readable medium with non-transitory program code recorded thereon is disclosed. The program code is executed by a processor and includes program code to transmit, to a wireless communication device including a group of reflector devices, a first beam associated with a first beam direction. The program code further includes program code to receive, from one reflector device of the group of reflector devices based on transmitting the first beam, a first message including a first beam tracking report that includes one or more first parameters associated with a second beam direction corresponding to a predicted position of the wireless communication device at a future time based on a motion and a speed of the wireless communication device. The program code still further includes program code to transmit, to the wireless communication device, a second beam associated with the second beam direction based on the one or more first parameters.

Another aspect of the present disclosure is directed to an apparatus including a processor, and a memory coupled with the processor and storing instructions operable, when executed by the processor, to cause the apparatus to transmit, to a wireless communication device including a group of reflector devices, a first beam associated with a first beam direction. Execution of the instructions also cause the apparatus to receive, from one reflector device of the group of reflector devices based on transmitting the first beam, a first message including a first beam tracking report that includes one or more first parameters associated with a second beam direction corresponding to a predicted position of the wireless communication device at a future time based on a motion and a speed of the wireless communication device. Execution of the instructions further cause the apparatus to transmit, to the wireless communication device, a second beam associated with the second beam direction based on the one or more first parameters.

Aspects generally include a method, apparatus, system, computer program product, non-transitory computer-readable medium, user equipment, base station, wireless communication device, and processing system as substantially described with reference to and as illustrated by the accompanying drawings and specification.

The foregoing has outlined rather broadly the features and technical advantages of examples according to the disclosure in order that the detailed description that follows may be better understood. Additional features and advantages will be described. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that features of the present disclosure can be understood in detail, a particular description may be had by reference to aspects, some of which are illustrated in the appended drawings. It is to be noted, however, that the appended drawings illustrate only certain aspects of this disclosure and are therefore not to be considered limiting of its scope, for the description may admit to other equally effective aspects. The same reference numbers in different drawings may identify the same or similar elements.

FIG. 1 is a block diagram conceptually illustrating an example of a wireless communications network, in accordance with various aspects of the present disclosure.

FIG. 2 is a block diagram conceptually illustrating an example of a base station in communication with a user equipment (UE) in a wireless communications network, in accordance with various aspects of the present disclosure.

FIG. 3 is a block diagram illustrating an example disaggregated base station architecture, in accordance with various aspects of the present disclosure.

FIG. 4 is a block diagram illustrating an example of a wireless communication device communicating with a base station, in accordance with various aspects of the present disclosure.

FIG. 5A is a block diagram illustrating an example of losing a signal based on movement of a wireless communication device.

FIG. 5B is a block diagram illustrating an example of updating a beam direction from a base station based on a wireless communication device transmitting a beam tracking report, in accordance with various aspects of the present disclosure.

FIG. 5C is a block diagram illustrating an example of directing a beam direction to a specific reflector device from a group of reflector devices, in accordance with various aspects of the present disclosure.

FIG. 6 is a block diagram illustrating an example wireless communication device that supports beam tracking, in accordance with some aspects of the present disclosure.

FIG. 7 is a flow diagram illustrating an example process performed by a wireless communication device that supports beam management, in accordance with some aspects of the present disclosure.

FIG. 8 is a block diagram illustrating an example wireless communication device that supports updating a beam direction based on receiving a beam tracking report, in accordance with aspects of the present disclosure.

FIG. 9 is a flow diagram illustrating an example process performed by a base station that supports beam management, in accordance with some aspects of the present disclosure

### DETAILED DESCRIPTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method, which is practiced using other structure, functionality, or structure and functionality in addition to or other than the various aspects of the disclosure set forth. It should be understood that any aspect of the disclosure disclosed may be embodied by one or more elements of a claim.

Several aspects of telecommunications systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described using terminology commonly associated with 5G and later wireless technologies, aspects of the present disclosure can be applied in other generation-based communications systems, such as and including 3G, 4G, or 6G technologies.

A wireless communication device, such as a user equipment (UE) or a reconfigurable intelligent surface (RIS), may be equipped or integrated with a set of reflector devices, such as modulated retro reflectors (MRRs) or smart repeaters. In some examples, the set of reflector devices may be used particularly for short range communications associated with high throughput and low latency. In some examples, one or more reflector devices of the set of reflector devices may receive, from a network node, one or more signals (for example, optical wireless communication (OWC) beams) and reflect the one or more received signals to the network node to establish a communication link. In some such examples, after establishing the communication link, the network node may keep track of a best beam direction to maintain the communication link while satisfying quality of service (QoS) requirements. In some examples, the QoS requirements may include one or both of a throughput requirement or a latency requirement. In some examples, the wireless communication device may move through an environment and the network node may be unaware of an actual direction of travel. Additionally, in some such examples, a width of the one or more received signals may be narrow relative to a size of each of the reflector devices. Therefore, the wireless communication device should provide, to the base station, information indicating a desired beam direction that corresponds to an estimated or predicted future position of the wireless communication device. The failure to provide such information may result in a loss of the communication link. Some conventional wireless communication devices use a stand-alone transmitter, such as a UE laser source or a radio frequency (RF) transmitter, to transmit a message indicating the desired beam direction to the network node. However, the use of such a stand-alone transmitter increases power consumption at the wireless communication device and increases a complexity of the wireless communication device.

Various aspects disclosed relate generally to signaling one or more parameters to manage a beam direction associated with a downlink signal (for example, an OWC beam or RF signal) from a network node. For ease of explanation, the downlink signal may be referred to as a beam. Some aspects more specifically relate to tracking motion or velocity (for example, one or more of position, direction of motion, or rate of motion) of a wireless communication device (for example, an OWC device, a RIS, or a UE) and managing a beam direction associated with a beam based on predicting or estimating a future position, a current direction of motion, a current rate of motion, and/or a future orientation of the wireless communication device based on the tracked motion or velocity. In some aspects, the wireless communication device may also manage a time for adjusting the beam direction.

In various aspects, the wireless communication device may be equipped or integrated with a set of reflector devices, such as MRRs or smart repeaters. In some examples, each reflector device in the set of reflector devices may be the same type of reflector device. While in operation, one or more reflector devices of the set of reflector devices may receive, from a network node, a first beam associated with a first beam direction. In some such examples, based on receiving the first beam, the wireless communication device may transmit, to the network node, a message including a beam tracking report. In some aspects, the message may be transmitted (for example, reflected) by reflecting the first beam back to the network node along the first beam direction via the one or more reflector devices that received the first beam. In some examples, the wireless communication device may transmit the message using a code division multiple access (CDMA) waveform or a single carrier (SC) waveform. In such examples, the message may be modulated based on on-off keying or pulse amplitude modulation. In some other examples, the wireless communication device may transmit the message by modulating a payload included in the first beam such that the modulated payload forms the message.

In some aspects, the message may include one or more parameters associated with tracking the motion or velocity of the wireless communication device. For example, as indicated above, the parameters may be associated with, a predicted future position, a current direction of motion, a current rate of motion, and/or a future orientation of the wireless communication device. The network node may then determine a second beam direction that may be associated with the predicted future position of the wireless communication device based on the parameters. Additionally, or alternatively, the one or more parameters included in the message may second beam direction. The second beam direction may be associated with the predicted future position of the wireless communication device based on predicting or estimating the future position, the current direction of motion, the current rate of motion and/or the future orientation of the wireless communication device. After receiving the message, the network node may transmit, to the wireless communication device, a second beam associated with the second beam direction.

Particular aspects of the subject matter described in this disclosure can be implemented to realize one or more of the following potential advantages. In some examples, by transmitting, to a network node, a message including a beam tracking report that includes one or more parameters associated with a predicted future position, a current direction of motion, a current rate of motion, and/or a future orientation of the wireless communication device or a desired beam direction corresponding to the predicted future position, of the wireless communication device, the wireless communication device may assist the network node in controlling a direction of a subsequent beam. Controlling the direction of the subsequent beam based on predicting, or estimating, the future position, the current direction of motion, the current rate of motion, and/or the future orientation of the wireless communication device may enable the wireless communication device to maintain a communication link with the network node and satisfy one or more QoS requirements. Additionally, in some examples, by using the one or more reflector devices to transmit the message via a reflected beam, both a complexity of the wireless communication device and a power consumption at the wireless communication device may be reduced because a stand-alone transmitter to transmit the message to the network node is not required.

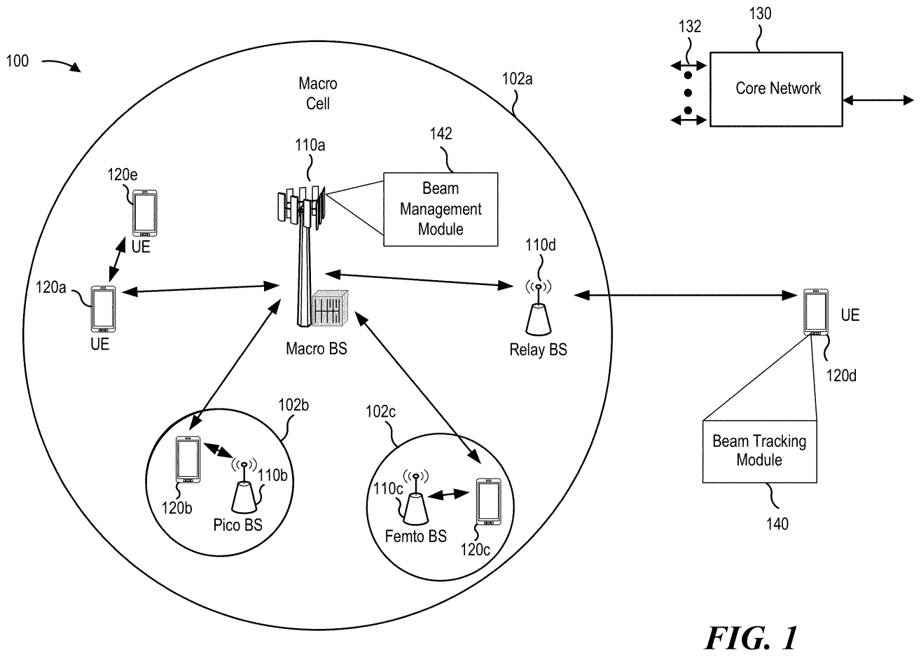

FIG. 1 is a diagram illustrating a network 100 in which aspects of the present disclosure may be practiced. The network 100 may be a 5G or NR network or some other wireless network, such as an LTE network. The wireless network 100 may include a number of BSs 110 (shown as BS 110a, BS 110b, BS 110c, and BS 110d) and other network entities. A BS is an entity that communicates with user equipment (UEs) and may also be referred to as a base station, an NR BS, a Node B, a gNB, a 5G Node B, an access point, a transmit and receive point (TRP), a network node, a network entity, or the like. A base station can be implemented as an aggregated base station, as a disaggregated base station, an integrated access and backhaul (IAB) node, a relay node, a sidelink node, etc. The base station can be implemented in an aggregated or monolithic base station architecture, or alternatively, in a disaggregated base station architecture, and may include one or more of a central unit (CU), a distributed unit (DU), a radio unit (RU), a near-real time (near-RT) RAN intelligent controller (RIC), or a non-real time (non-RT) RIC.

Each BS may provide communications coverage for a particular geographic area. In 3GPP, the term “cell” can refer to a coverage area of a BS or a BS subsystem serving this coverage area, depending on the context in which the term is used.

A BS may provide communications coverage for a macro cell, a pico cell, a femto cell, or another type of cell. A macro cell may cover a relatively large geographic area (for example, several kilometers in radius) and may allow unrestricted access by UEs with service subscription. A pico cell may cover a relatively small geographic area and may allow unrestricted access by UEs with service subscription. A femto cell may cover a relatively small geographic area (for example, a home) and may allow restricted access by UEs having association with the femto cell (for example, UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (for example, three) cells. The terms “eNB,” “base station,” “NR BS,” “gNB,” “AP,” “Node B,” “5G NB,” “TRP,” and “cell” may be used interchangeably.

In some aspects, a cell may not necessarily be stationary, and the geographic area of the cell may move according to the location of a mobile BS. In some aspects, the BSs may be interconnected to one another or to one or more other BSs or network nodes (not shown) in the wireless network 100 through various types of backhaul interfaces such as a direct physical connection, a virtual network, or the like using any suitable transport network.

The wireless network 100 may also include relay stations. A relay station is an entity that can receive a transmission of data from an upstream station (for example, a BS or a UE) and send a transmission of the data to a downstream station (for example, a UE or a BS). A relay station may also be a UE that can relay transmissions for other UEs. In the example shown in FIG. 1, a relay station 110d may communicate with macro BS 110a and a UE 120d in order to facilitate communications between the BS 110a and UE 120d. A relay station may also be referred to as a relay BS, a relay base station, a relay, or the like.

The wireless network 100 may be a heterogeneous network that includes BSs of different types (for example, macro BSs, pico BSs, femto BSs, relay BSs, or the like). These different types of BSs may have different transmit power levels, different coverage areas, and different impact on interference in the wireless network 100. For example, macro BSs may have a high transmit power level (for example, 5 to 40 watts) whereas pico BSs, femto BSs, and relay BSs may have lower transmit power levels (for example, 0.1 to 2 watts).

As an example, the BSs 110 (shown as BS 110a, BS 110b, BS 110c, and BS 110d) and the core network 130 may exchange communications via backhaul links 132 (for example, S1, etc.). Base stations 110 may communicate with one another over other backhaul links (for example, X2, etc.) either directly or indirectly (for example, through core network 130).

The core network 130 may be an evolved packet core (EPC), which may include at least one mobility management entity (MME), at least one serving gateway (S-GW), and at least one packet data network (PDN) gateway (P-GW). The MME may be the control node that processes the signaling between the UEs 120 and the EPC. All user IP packets may be transferred through the S-GW, which itself may be connected to the P-GW. The P-GW may provide IP address allocation as well as other functions.

The P-GW may be connected to the network operator's IP services. The operator's IP services may include the Internet, the Intranet, an IP multimedia subsystem (IMS), and a packet-switched (PS) streaming service.

The core network 130 may provide user authentication, access authorization, tracking, IP connectivity, and other access, routing, or mobility functions. One or more of the base stations 110 or access node controllers (ANCs) may interface with the core network 130 through backhaul links 132 (for example, S1, S2, etc.) and may perform radio configuration and scheduling for communications with the UEs 120. In some configurations, various functions of each access network entity or base station 110 may be distributed across various network devices (for example, radio heads and access network controllers) or consolidated into a single network device (for example, a base station 110).

UEs 120 (for example, 120a, 120 b, 120 c) may be dispersed throughout the wireless network 100, and each UE may be stationary or mobile. A UE may also be referred to as an access terminal, a terminal, a mobile station, a subscriber unit, a station, or the like. A UE may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (for example, smart ring, smart bracelet)), an entertainment device (for example, a music or video device, or a satellite radio), a vehicular component or sensor, smart meters/sensors, industrial manufacturing equipment, a global positioning system device, or any other suitable device that is configured to communicate via a wireless or wired medium.

One or more UEs 120 may establish a protocol data unit (PDU) session for a network slice. In some cases, the UE 120 may select a network slice based on an application or subscription service. By having different network slices serving different applications or subscriptions, the UE 120 may improve its resource utilization in the wireless network 100, while also satisfying performance specifications of individual applications of the UE 120. In some cases, the network slices used by UE 120 may be served by an AMF (not shown in FIG. 1) associated with one or both of the base station 110 or core network 130. In addition, session management of the network slices may be performed by an access and mobility management function (AMF).

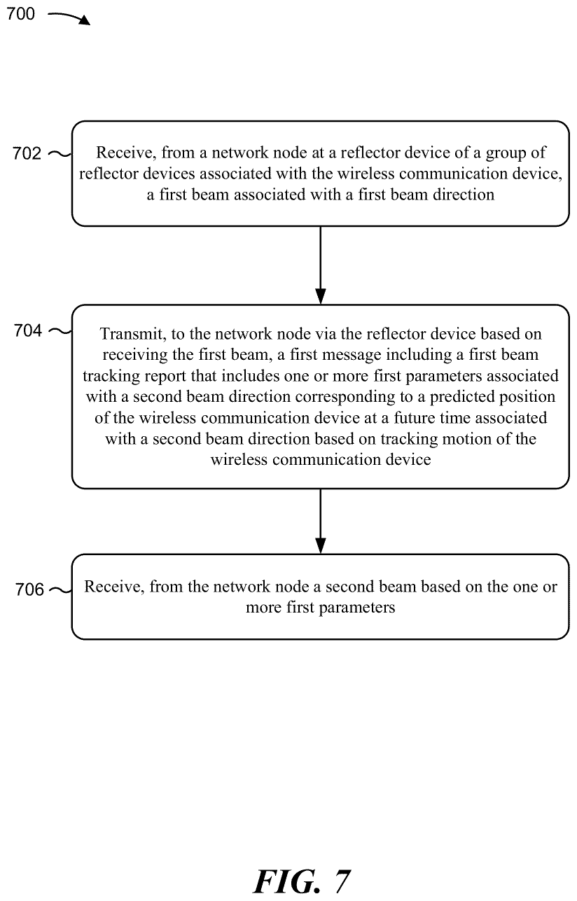

The UEs 120 may include a beam tracking module 140. For brevity, only one UE 120d is shown as including the beam tracking module 140. The beam tracking module 140 may perform one or more operations, including operations of the process 700 described below with reference to FIG. 7

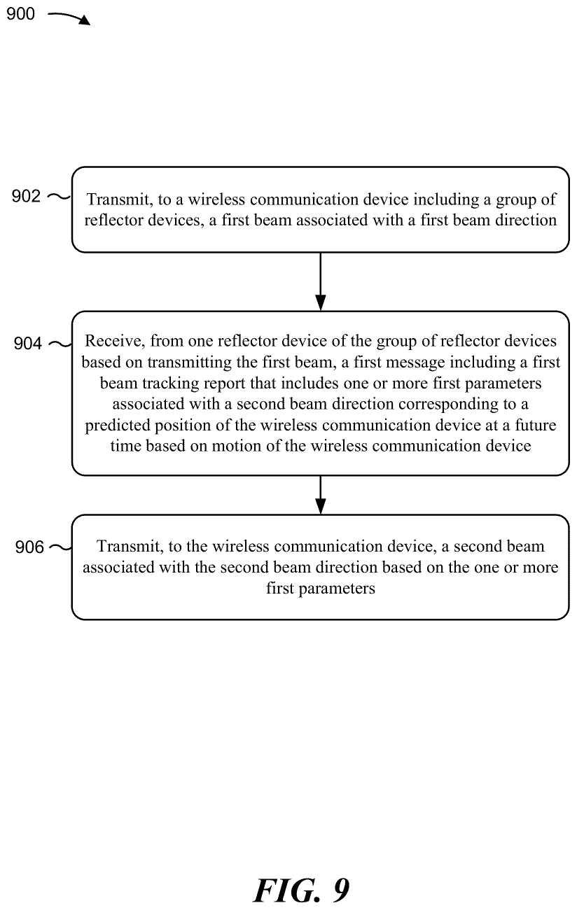

The base station 110 may include a beam management module 142. For brevity, only one base station 110 is shown as including the beam management module 142. The beam management module 142 may perform one or more operations, including operations of the process 900 described below with reference to FIG. 9.

Some UEs may be considered machine-type communications (MTC) or evolved or enhanced machine-type communications (eMTC) UEs. MTC and eMTC UEs include, for example, robots, drones, remote devices, sensors, meters, monitors, location tags, or the like, that may communicate with a base station, another device (for example, remote device), or some other entity. A wireless node may provide, for example, connectivity for or to a network (for example, a wide area network such as Internet or a cellular network) via a wired or wireless communication link. Some UEs may be considered Internet-of-Things (IoT) devices, or may be implemented as NB-IoT (narrowband internet of things) devices. Some UEs may be considered a customer premises equipment (CPE). UE 120 may be included inside a housing that houses components of UE 120, such as processor components, memory components, or the like.

In general, any number of wireless networks may be deployed in a given geographic area. Each wireless network may support a particular radio access technology (RAT) and may operate on one or more frequencies. A RAT may also be referred to as a radio technology, an air interface, or the like. A frequency may also be referred to as a carrier, a frequency channel, or the like. Each frequency may support a single RAT in a given geographic area in order to avoid interference between wireless networks of different RATs. In some cases, NR or 5G RAT networks may be deployed.

In some aspects, two or more UEs 120 (for example, shown as UE 120a and UE 120e) may communicate directly using one or more sidelink channels (for example, without using a base station 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or the like), a mesh network, or the like. In this case, the UE 120 may perform scheduling operations, resource selection operations, or other operations described elsewhere as being performed by the base station 110. For example, the base station 110 may configure a UE 120 via downlink control information (DCI), radio resource control (RRC) signaling, a media access control-control element (MAC-CE) or via system information (for example, a system information block (SIB).

As indicated above, FIG. 1 is provided merely as an example. Other examples may differ from what is described with regard to FIG. 1.

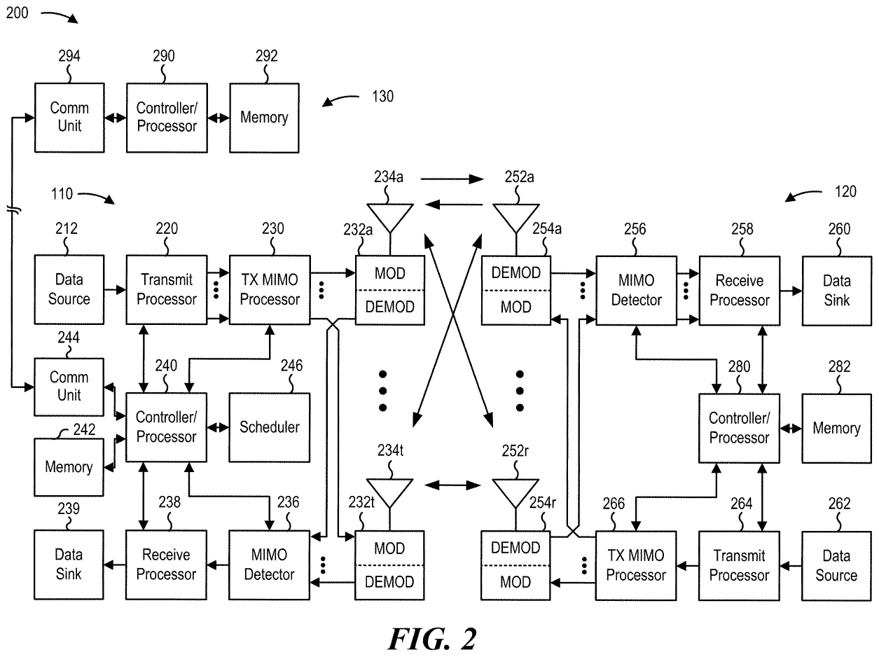

FIG. 2 shows a block diagram of a design 200 of the base station 110 and UE 120, which may be one of the base stations and one of the UEs in FIG. 1. The base station 110 may be equipped with T antennas 234a through 234t, and UE 120 may be equipped with R antennas 252a through 252r, where in general T≥1 and R≥1.

At the base station 110, a transmit processor 220 may receive data from a data source 212 for one or more UEs, select one or more modulation and coding schemes (MCS) for each UE based at least in part on channel quality indicators (CQIs) received from the UE, process (for example, encode and modulate) the data for each UE based at least in part on the MCS(s) selected for the UE, and provide data symbols for all UEs. Decreasing the MCS lowers throughput but increases reliability of the transmission. The transmit processor 220 may also process system information (for example, for semi-static resource partitioning information (SRPI) or the like) and control information (for example, CQI requests, grants, upper layer signaling, or the like) and provide overhead symbols and control symbols. The transmit processor 220 may also generate reference symbols for reference signals (for example, the cell-specific reference signal (CRS)) and synchronization signals (for example, the primary synchronization signal (PSS) and secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide T output symbol streams to T modulators (MODs) 232a through 232t. Each modulator 232 may process a respective output symbol stream (for example, for orthogonal frequency division multiplexing (OFDM) or the like) to obtain an output sample stream. Each modulator 232 may further process (for example, convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At the UE 120, antennas 252a through 252r may receive the downlink signals from the base station 110 or other base stations and may provide received signals to demodulators (DEMODs) 254a through 254r, respectively. Each demodulator 254 may condition (for example, filter, amplify, downconvert, and digitize) a received signal to obtain input samples. Each demodulator 254 may further process the input samples (for example, for OFDM or the like) to obtain received symbols. A MIMO detector 256 may obtain received symbols from all R demodulators 254a through 254r, perform MIMO detection on the received symbols if applicable, and provide detected symbols. A receive processor 258 may process (for example, demodulate and decode) the detected symbols, provide decoded data for the UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), or the like. In some aspects, one or more components of the UE 120 may be included in a housing.

On the uplink, at the UE 120, a transmit processor 264 may receive and process data from a data source 262 and control information (for example, for reports comprising RSRP, RSSI, RSRQ, CQI, or the like) from the controller/processor 280. Transmit processor 264 may also generate reference symbols for one or more reference signals. The symbols from the transmit processor 264 may be precoded by a TX MIMO processor 266 if applicable, further processed by modulators 254a through 254r (for example, for discrete Fourier transform spread OFDM (DFT-s-OFDM), CP-OFDM, or the like), and transmitted to the base station 110. At the base station 110, the uplink signals from the UE 120 and other UEs may be received by the antennas 234, processed by the demodulators 254, detected by a MIMO detector 236 if applicable, and further processed by a receive processor 238 to obtain decoded data and control information sent by the UE 120. The receive processor 238 may provide the decoded data to a data sink 239 and the decoded control information to a controller/processor 240. The base station 110 may include communications unit 244 and communicate to the core network 130 via the communications unit 244. The core network 130 may include a communications unit 294, a controller/processor 290, and a memory 292.

One or more of the controller/processor 240 of the base station 110, the controller/processor 280 of the UE 120, or any other component(s) of FIG. 2 may perform one or more techniques associated with beam tracking as described in more detail elsewhere. For example, one or more of the controller/processor 240 of the base station 110, the controller/processor 280 of the UE 120, or any other component(s) of FIG. 2 may perform or direct operations of, for example, one or more of the processes of FIGS. 7 and 9, or other processes as described. Memories 242 and 282 may store data and program codes for the base station 110 and UE 120, respectively. A scheduler 246 may schedule UEs for data transmission on the downlink or uplink.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), an evolved NB (eNB), an NR BS, 5G NB, an access point (AP), a transmit and receive point (TRP), or a cell, etc.) may be implemented as an aggregated base station (also known as a stand-alone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units (for example, a virtual central unit (VCU), a virtual distributed unit (VDU), or a virtual radio unit (VRU)).

Base station-type operations or network designs may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

In some cases, different types of devices supporting different types of applications or services may coexist in a cell. Examples of different types of devices include UE handsets, customer premises equipment (CPEs), vehicles, Internet of Things (IoT) devices, or the like. Examples of different types of applications include ultra-reliable low-latency communications (URLLC) applications, massive machine-type communications (mMTC) applications, enhanced mobile broadband (eMBB) applications, vehicle-to-anything (V2X) applications, or the like. Furthermore, in some cases, a single device may support different applications or services simultaneously.

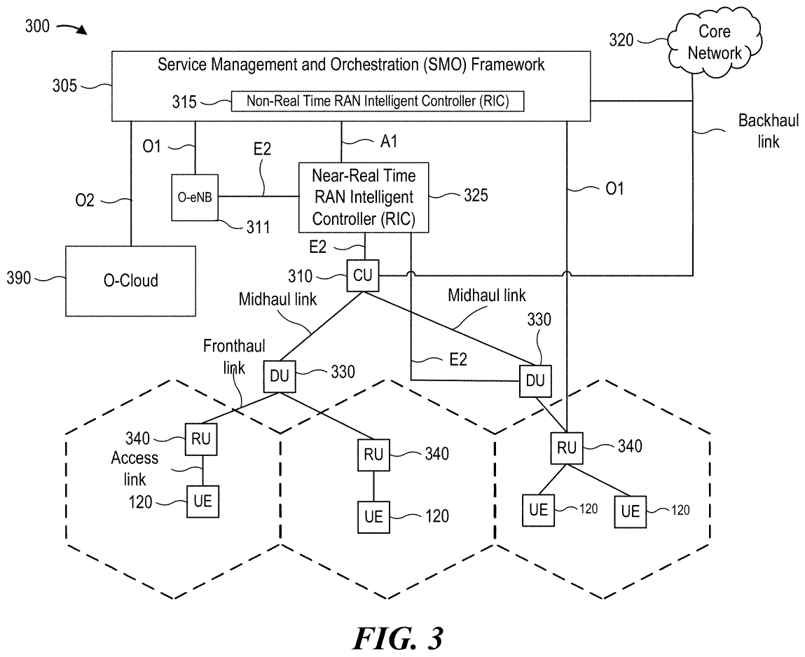

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a near-real time (near-RT) RAN intelligent controller (RIC) 325 via an E2 link, or a non-real time (non-RT) RIC 315 associated with a service management and orchestration (SMO) framework 305, or both). A CU 310 may communicate with one or more distributed units (DUs) 330 via respective midhaul links, such as an F1 interface. The DUs 330 may communicate with one or more radio units (RUS) 340 via respective fronthaul links. The RUs 340 may communicate with respective UEs 120 via one or more radio frequency (RF) access links. In some implementations, the UE 120 may be simultaneously served by multiple RUs 340.

Each of the units (for example, the CUS 310, the DUs 330, the RUs 340, as well as the near-RT RICs 325, the non-RT RICs 315, and the SMO framework 305) may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units.

Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (for example, central unit-user plane (CU-UP)), control plane functionality (for example, central unit-control Plane (CU-CP)), or a combination thereof. In some implementations, the CU 310 can be logically split into one or more CU-UP units and one or more CU-CP units. The CU-UP unit can communicate bi-directionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the Third Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO framework 305 may be configured to support RAN deployment and provisioning of non-virtualized and virtualized network elements. For non-virtualized network elements, the SMO framework 305 may be configured to support the deployment of dedicated physical resources for RAN coverage requirements, which may be managed via an operations and maintenance interface (such as an O1 interface). For virtualized network elements, the SMO framework 305 may be configured to interact with a cloud computing platform (such as an open cloud (O-cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340, and near-RT RICs 325. In some implementations, the SMO framework 305 can communicate with a hardware aspect of a 4G RAN, such as an open eNB (O-eNB) 311, via an O1 interface. Additionally, in some implementations, the SMO framework 305 can communicate directly with one or more RUs 340 via an O1 interface. The SMO framework 305 also may include a non-RT RIC 315 configured to support functionality of the SMO framework 305.

The non-RT RIC 315 may be configured to include a logical function that enables non-real-time control and optimization of RAN elements and resources, artificial intelligence/machine learning (AI/ML) workflows including model training and updates, or policy-based guidance of applications/features in the near-RT RIC 325. The non-RT RIC 315 may be coupled to or communicate with (such as via an A1 interface) the near-RT RIC 325. The near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as the O-eNB 311, with the near-RT RIC 325.

In some implementations, to generate AI/ML models to be deployed in the near-RT RIC 325, the non-RT RIC 315 may receive parameters or external enrichment information from external servers. Such information may be utilized by the near-RT RIC 325 and may be received at the SMO framework 305 or the non-RT RIC 315 from non-network data sources or from network functions. In some examples, the non-RT RIC 315 or the near-RT RIC 325 may be configured to tune RAN behavior or performance. For example, the non-RT RIC 315 may monitor long-term trends and patterns for performance and employ AI/ML models to perform corrective actions through the SMO framework 305 (such as reconfiguration via O1) or via creation of RAN management policies (such as A1 policies).

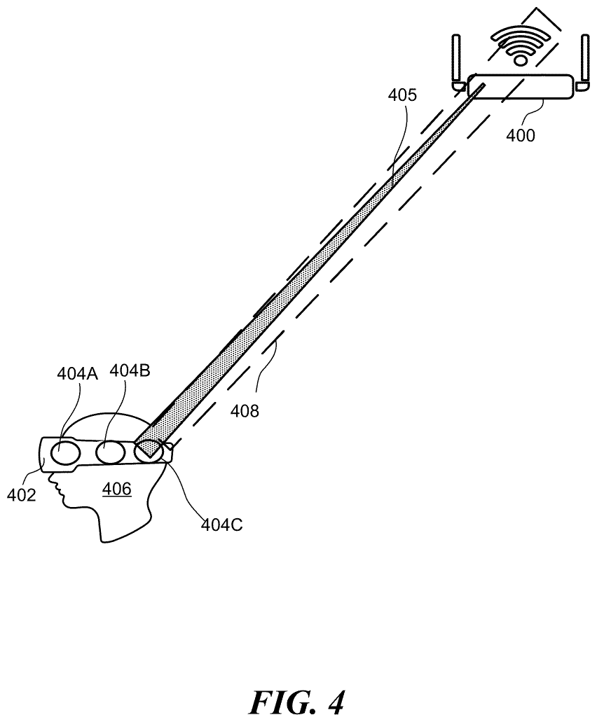

As discussed, reflector devices, such as an MRR or a smart repeater of a RIS, may receive a signal and reflect the received signal back to a source of the signal or to another device. FIG. 4 is a block diagram illustrating an example of a wireless communication device 402 communicating with a network node 400, in accordance with various aspects of the present disclosure. In some examples, the wireless communication device 402 may be an example of a UE 120 described with reference to FIGS. 1, 2, and 3. In other examples, the wireless communication device 402 may be a wearable device, such as a virtual reality headset, that is worn by a user 406. The wearable device may be used for gaming, computer aided drafting, holographic conferencing, or other tasks that may specify high throughput and low latency communications. In some such examples, the wireless communication device 402 may be an example of an OWC device or a RIS. The wireless communication device 402 may include one or more reflector devices 404A, 404B, and 404C. In some examples, each reflector device 404A, 404B, and 404C may be an MRR. In some other examples, each reflector device 404A, 404B, and 404C may be a RIS or a smart repeater associated with a RIS. The wireless communication device 402 is not limited to three reflector devices 404A, 404B, and 404C, as shown in FIG. 4. Additional or fewer reflector devices 404A, 404B, and 404C may be integrated with the wireless communication device 402. As an example, other reflector devices may be integrated on a side (for example, a right side) of the wireless communication device 402 that is not shown in FIG. 4. In some examples, the network node 400 may be an example of a base station 110 described with reference to FIGS. 1 and 2, or DU 330, RU 340, or CU 310 described with reference to FIG. 3. In other examples, the network node 400 may be an example of an indoor network node.

As shown in FIG. 4, the wireless communication device 402 may receive a downlink signal 405 transmitted from the network node 400. The downlink signal 405 may be an example of an OWC beam or an RF signal. In some examples, the downlink signal 405 is received at one of the reflector devices 404A, 404B, and 404C, such as the third reflector device 404C, and then reflected back to the network node 400 at a same angle as the downlink signal 405. In the example of FIG. 4, an uplink signal 408 is an example of a reflection of the downlink signal 405. In contrast to the wireless communication device 402, conventional receivers may generate a signal via a transceiver that is transmitted to the network node 400 based on receiving the downlink signal 405. As an example, conventional receivers may generate a laser at a laser source. The use of the transceiver may increase power consumption at the receiver. In contrast, the reflector devices 404A, 404B, and 404C may reduce power consumption at the wireless communication device 402 while also simplifying a design of the wireless communication device 402. Additionally, the use of the reflector devices 404A, 404B, and 404C simplifies beam management at the wireless communication device 402 because the downlink signal 405 is reflected back to the network node 400. Furthermore, a wider field of view optics may be available to the wireless communication device 402 based on the use of an asymmetric link.

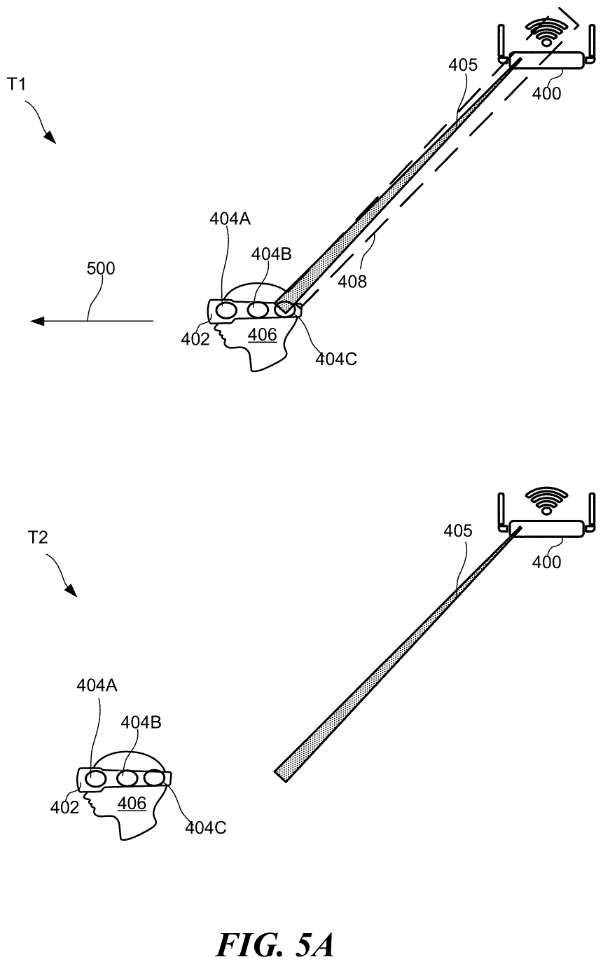

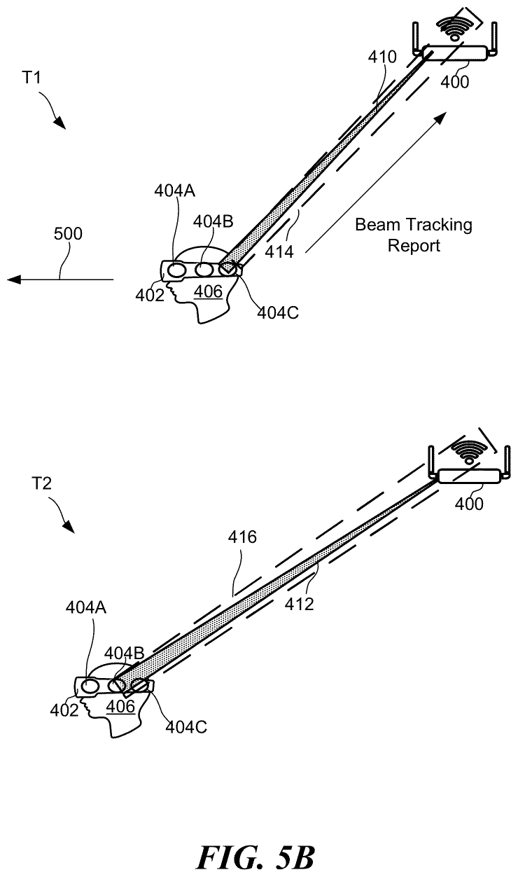

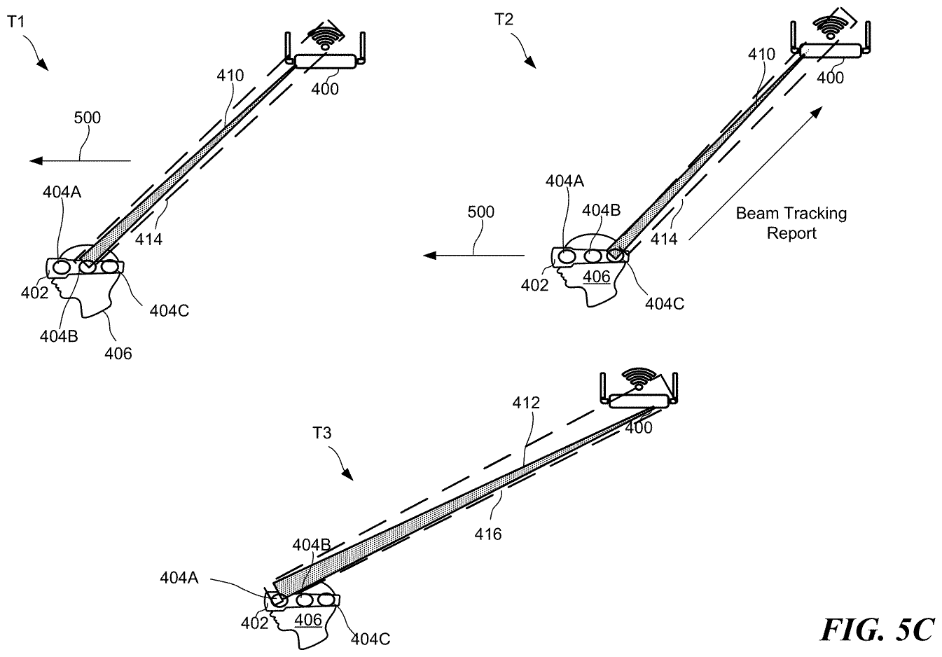

In some examples, the wireless communication device 402 may move through an environment, causing a loss of the downlink signal 405. FIG. 5A is a block diagram illustrating an example of losing a downlink signal 405 based on movement of a wireless communication device 402. In the example of FIG. 5A, at time t1, a wireless communication device 402 receives a downlink signal 405 from a network node 400 in a beam direction (for example, downlink signal direction). The beam direction may be toward a current location of the wireless communication device 402. In some examples, the downlink signal 405 is repeatedly transmitted by the network node 400. The repeated transmission may be different than a continuous transmission, which is an example of an uninterrupted transmission. For example, the repeated transmission may be repeated at an interval (for example, once every millisecond). As shown in FIG. 5A, at time t1, an uplink signal 408 is an example of a reflection of the downlink signal 405 back to the network node 400. As discussed, one or more of the reflector devices 404A, 404B, and 404C may reflect the downlink signal 405. Additionally, as shown in FIG. 5A, at time t1, the user 406 may move in a direction 500.

In the example of FIG. 5A, at time t2, the user 406 moved in the direction 500. However, the wireless communication device 402 did not transmit a report to the network node 400 indicating a new beam direction based on the movement of the wireless communication device 402. Therefore, at time t2, the network node 400 did not update the beam direction of the downlink signal 405. Thus, the downlink signal 405 was not received at one or more reflector devices 404A, 404B, and 404C of the wireless communication device 402 resulting in a loss of the downlink signal 405 at the wireless communication device 402. The loss of the downlink signal 405 (for example, communication link) may cause one or more of a poor user experience, application failure, increased latency, or reduced throughput. To reduce a possibility of the wireless communication device 402 losing the downlink signal 405, the network node 400 may keep track of a best beam direction with respect to a location of the wireless communication device 402. The best beam direction may be a direction that achieves one or both of a maximum throughput or a minimum latency. In some examples, such as when the downlink signal 405 is a laser beam, a width of the downlink signal 405 may be narrow compared to a size of the wireless communication device 402.

Therefore, the wireless communication device 402 may assist the network node 400 in keeping track of the best beam direction.

In some examples, to reduce the possibility of losing the downlink signal 405, the wireless communication device 402 may transmit, to the network node 400, a beam tracking report that includes one or more parameters associated with an updated beam direction based on tracking motion and speed of the wireless communication device 402. In some examples, the wireless communication device 402 may repeatedly track its own motion to predict a future position, tracking its own motion may include tracking one or more of a direction of movement, a direction of travel, a speed, or velocity. The repeated tracking refers to tracking the motion at an interval, such as once every millisecond. In some examples, the repeated tracking may be distinguishable from continuous tracking (for example, uninterrupted tracking). In some examples, the beam tracking report may be repeatedly transmitted to the network node 400 as the wireless communication device 402 moves through an environment. The beam tracking report may increase a reliability of a link between the network node 400 and the wireless communication device 402.

FIG. 5B is a block diagram illustrating an example of updating a beam direction from a network node 400 based on a wireless communication device 402 transmitting a beam tracking report, in accordance with various aspects of the present disclosure. In the example of FIG. 5B, at time tl1a wireless communication device 402 receives a first downlink signal 410 from a network node 400 in a first beam direction. The first beam direction may be toward a current location of the wireless communication device 402. In some examples, the first downlink signal 410 is repeatedly transmitted by the network node 400. As shown in FIG. 5B, at time t1, a first uplink signal 414 is transmitted to the network node 400. The first uplink signal 414 may be an example of a reflection of the first downlink signal 410 back to the network node 400. As discussed, one or more of the reflector devices 404A, 404B, and 404C may reflect the first downlink signal 410. Additionally, as shown in FIG. 5B, at time t1, the user 406 may move in a direction 500.

In the example of FIG. 5B, the wireless communication device 402 may track its own motion and speed. Based on the motion and speed tracking, the wireless communication device 402 may transmit a first message including a first beam tracking report that includes one or more first parameters associated with one or both of a direction of motion of the wireless communication device 402 or a second beam direction associated with a predicted position of the wireless communication device 402 at a future time. In such examples, the predicted position of the wireless communication device 402 at the future time may be based on the wireless communication device 402 tracking its motion and speed within the environment. In some examples, the motion and speed may be repeatedly tracked. Additionally, in some examples, the wireless communication device 402 may estimate a direction of its motion based on one or both of an energy measurement of the first downlink signal 410 by one or more reflector devices 404A, 404B, and 404C, or a motion measurement by one or more sensors associated with the wireless communication device 402. The one or more sensors may include one or more gyro sensors, a positioning sensor, or another type of location sensor or motion sensor. In such examples, the second beam direction may be based on estimating the direction of motion of the wireless communication device 402. Additionally, or alternatively, the direction of motion may be estimated based on information obtained from an application that is being executed at the wireless communication device 402. For example, a video game may indicate that the user 406 may move in a specific direction based on an upcoming event in the video game.

Therefore, the estimated direction of motion may correspond to the specific direction indicated by the video game. In some examples, the direction of motion may be estimated according to six degrees of freedom (for example, a location and pose of the wireless communication device 402).

In some examples, the one or more first parameters may include a difference between the first beam direction and the second beam direction, or an absolute value corresponding to an adjustment to the first beam direction. For example, the absolute value may be in radians or degrees. Additionally, or alternatively, the one or more first parameters indicate the direction 500 of motion. Additionally, or alternatively, the one or more first parameters may indicate an altitude and an azimuth associated with the second beam direction. The altitude and the azimuth may correspond to respective axes in a coordinate system. Additionally, or alternatively, the one or more first parameters may indicate a time for receiving a second downlink signal 412, at time t2, in the second beam direction. For example, the one or more first parameters may indicate the second downlink signal 412 should be received at a certain period of time after a current time.

In other examples, the one or more first parameters indicate an altitude associated with the second beam direction. In such examples, the wireless communication device 402 may transmit a second message, based on receiving the first downlink signal 410, including a second beam tracking report that includes one or more second parameters associated with the second beam direction. The one or more second parameters indicate an azimuth associated with the second beam direction. In such examples, the wireless communication device 402 splits the beam tracking report into two payloads, such that the wireless communication device 402 transmits the first beam tracking report and then the second beam tracking report, or vice versa.

In some examples, the first message may be transmitted on a waveform, such as a code division multiple access (CDMA) waveform or a single carrier (SC) waveform. In such examples, the first message may be modulated via a modulation scheme, such as on-off keying (OOK) or pulse amplitude modulation (PAM). In some other examples, the wireless communication device 402 may modulate a downlink payload, such as an OWC payload, included in the first downlink signal 410. In such examples, the first message may be the modulated downlink payload.

As shown in the example of FIG. 5B, at time t2, the network node 400 may transmit the second downlink signal 412 associated with a second direction based on receiving the first message (for example, the first beam tracking report) at time t1. A second uplink signal 416 may be transmitted to the network node 400 based on one of the reflector devices 404A, 404B, or 404C reflecting the second downlink signal 412 back to the network node 400. In some examples, if a communication link between the wireless communication device 402 and the network node 400 is lost, a beam tracking report (for example, the first beam tracking report) may be directed to different communication bands or a beam management procedure may restart. Restarting the beam management procedure may re-establish the communication link between the wireless communication device 402 and the network node 400.

In the example of FIG. 5B, the first beam report indicates one or more parameters associated with a second beam direction corresponding to a predicted position of the wireless communication device based on the wireless communication device 402 tracking its motion and speed. In some examples, the desired beam direction or a correction to a direction of a current beam (for example, downlink signal) may be directed to a specific reflector device 404A, 404B, or 404C from a group of reflector devices.

FIG. 5C is a block diagram illustrating an example of directing a beam direction to a specific reflector device 404A, 404B, or 404C from a group of reflector devices, in accordance with various aspects of the present disclosure. In the example of FIG. 5C, at time t1, a wireless communication device 402 receives a first downlink signal 410 from a network node 400 associated with a first beam direction (for example, first downlink signal direction). The first beam direction may direct the first downlink signal 410 to a second reflector device 404B of the group of reflector devices. As discussed, the first downlink signal 410 may be repeatedly transmitted by the network node 400. As shown in FIG. 5C, at time t1, a first uplink signal 414 is transmitted to the network node 400 based on the second reflector device 404B reflecting the first downlink signal 410 back to the network node 400. The wireless communication device 402 may be aware that the second reflector device 404B is reflecting the first downlink signal 410 at time t1. Additionally, as shown in FIG. 5A, at time t1, the user 406 may move in a direction 500.

At time t2, based on the motion of the user 406 in the direction 500, the first downlink signal 410 may be received at a third reflector device 404C. Additionally, at time t2, the first uplink signal 414 may be transmitted to the network node 400 based on the third reflector device 404C reflecting the first downlink signal 410 back to the network node 400. The wireless communication device 402 may be aware that the third reflector device 404C is reflecting the first downlink signal 410 at time t2. Given the location of the third reflector device 404C in relation to the wireless communication device 402 (for example, the third reflector device 404C is defined at an edge of the wireless communication device 402), the reflector device 404C may determine that a communication link may be lost if the wireless communication device 402 continues to move in the direction 500. Therefore, at time t2, the wireless communication device 402 may transmit, to the network node 400, a first message that includes a first beam tracking report that includes one or more first parameters associated with a second beam direction corresponding to a predicted position of the wireless communication device 402 based on the wireless communication device 402 tracking its motion and speed.

In the example of FIG. 5C, the second beam direction may be a predicted, or estimated, direction toward a specific reflector device, such as a first reflector device 404A. In some examples, because the first downlink signal 410 moved from the second reflector device 404B to the third reflector device 404C, the wireless communication device 402 may direct the first downlink signal 410 to the first reflector device 404A in case the user continues to move in the direction 500. Thus, at time t3, the wireless communication device 402 receives a second downlink signal 412 in a second beam direction at the first reflector device 404A based on the one or more parameters included in the first beam tracking report. The wireless communication device 402 may continue to monitor a direction of the second downlink signal 412 and may send another beam tracking report once the second downlink signal 412 is received at the third reflector device 404C.

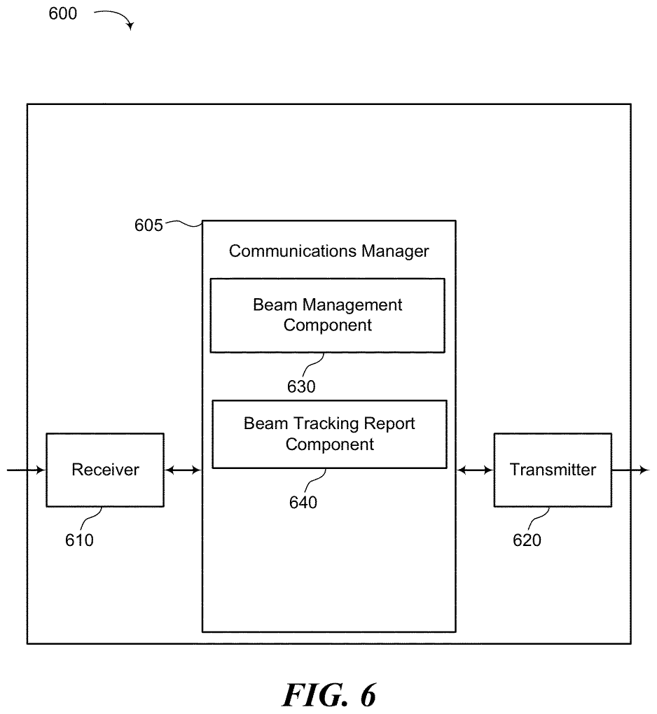

FIG. 6 is a block diagram illustrating an example wireless communication device 600 that supports beam tracking, in accordance with some aspects of the present disclosure. The device 600 may be an example of aspects of a UE 120 described with reference to FIGS. 1, 2, and 3, or a wireless communication device 402 described with reference to FIGS. 4, 5B, and 5C. The wireless communication device 600 may include a receiver 610, a communications manager 605, a transmitter 620, a beam management component 630 and a beam tracking report component 640 which may be in communication with one another (for example, via one or more buses). In some examples, the wireless communication device 600 is configured to perform operations, including operations of the process 700 described below with reference to FIG. 7.

In some examples, the wireless communication device 600 can include a chip, chipset, package, or device that includes at least one processor and at least one modem (for example, a 5G modem or other cellular modem). In some examples, the communications manager 605, or its sub-components, may be separate and distinct components. In some examples, at least some components of the communications manager 605 are implemented at least in part as software stored in a memory. For example, portions of one or more of the components of the communications manager 605 can be implemented as non-transitory code executable by the processor to perform the functions or operations of the respective component.

The receiver 610 may receive one or more reference signals (for example, periodically configured channel state information reference signals (CSI-RSs), aperiodically configured CSI-RSs, or multi-beam-specific reference signals), synchronization signals (for example, synchronization signal blocks (SSBs)), control information and data information, such as in the form of packets, from one or more other wireless communication devices via various channels including control channels (for example, a physical downlink control channel (PDCCH), physical uplink control channel (PUCCH), or physical sidelink control channel (PSCCH) and data channels (for example, a physical downlink shared channel (PDSCH), physical sidelink shared channel (PSSCH), a physical uplink shared channel (PUSCH)). The other wireless communication devices may include, but are not limited to, a base station 110 as described with reference to FIGS. 1 and 2, a CU 310, DU 330, or RU 340 as described with reference to FIG. 3, or a network node 400 described with reference to FIGS. 4, 5A, 5B, and 5C.

The received information may be passed on to other components of the device 600. The receiver 610 may be an example of aspects of the receive processor 256 described with reference to FIG. 2. The receiver 610 may include a set of radio frequency (RF) chains that are coupled with or otherwise utilize a set of antennas (for example, the set of antennas may be an example of aspects of the antennas 252 described with reference to FIG. 2).

The transmitter 620 may transmit signals generated by the communications manager 605 or other components of the wireless communication device 600. In some examples, the transmitter 620 may be collocated with the receiver 610 in a transceiver. The transmitter 620 may be an example of aspects of the transmit processor 266 described with reference to FIG. 2. The transmitter 620 may be coupled with or otherwise utilize a set of antennas (for example, the set of antennas may be an example of aspects of the antennas 252 described with reference to FIG. 2), which may be antenna elements shared with the receiver 610. In some examples, the transmitter 620 is configured to transmit control information in a PUCCH, PSCCH, or PDCCH and data in a physical uplink shared channel (PUSCH), PSSCH, or PDSCH.

The communications manager 605 may be an example of aspects of the controller/processor 259 described with reference to FIG. 2. The communications manager 605 may include the beam management component 630 and the beam tracking report component 640. In some examples, working in conjunction with the receiver 610, the beam management component 630 may receive, from a network node at a reflector device of a group of reflector devices associated with the wireless communication device, a first beam associated with a first beam direction. Additionally, working in conjunction with the beam management component 630 and the transmitter 620, the beam tracking report component 640 may transmit, to the network node via the reflector device based on receiving the first beam, a first message including a first beam tracking report that includes one or more first parameters associated with a second beam direction corresponding to a predicted position of the wireless communication device at a future time based on tracking motion of the wireless communication device. Finally, working in conjunction with one or more of the receiver 610 or the beam tracking report component 640, the beam management component 630 receives, from the network node, a second beam based on the one or more first parameters. The second beam may be associated with the second beam direction.

FIG. 7 is a flow diagram illustrating an example process 700 performed by a wireless communication device, in accordance with some aspects of the present disclosure. The wireless communication device may be an example of a wireless communication device 402 described with reference to FIG. 4. The example process 700 is an example of a beam management process. As shown in FIG. 7, the process 700 begins at block 702 by receiving, from a network node at a reflector device of a group of reflector devices associated with the wireless communication device, a first beam associated with a first beam direction. At block 704, the process 700 transmits, to the network node via the reflector device based on receiving the first beam, a first message including a first beam tracking report that includes one or more first parameters associated with a second beam direction corresponding to a predicted position of the wireless communication device at a future time based on tracking motion of the wireless communication device. At block 706, the process 700 receives, from the network node, a second beam based on the one or more first parameters. The second beam may be associated with the second beam direction.

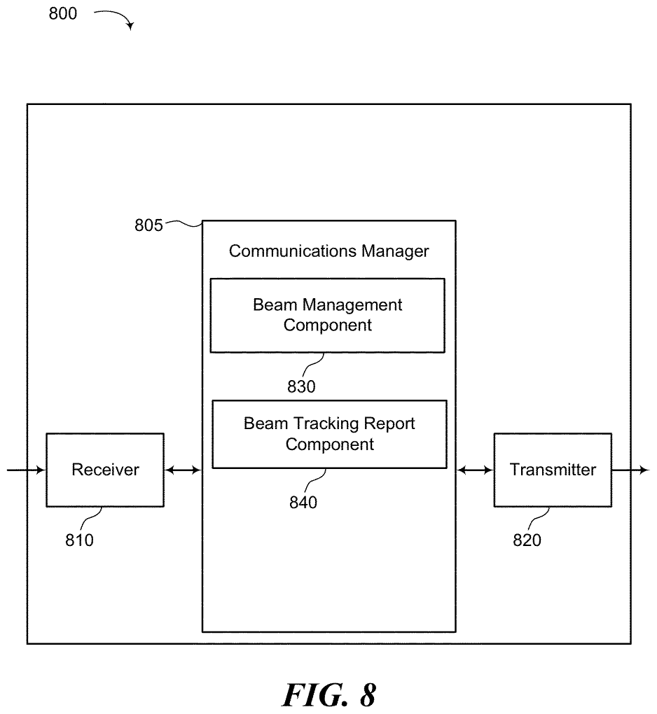

FIG. 8 is a block diagram illustrating an example wireless communication device 800 that supports updating a beam direction based on receiving a beam tracking report, in accordance with aspects of the present disclosure. The wireless communication device 800 may be an example of a network node 400 described with reference to FIGS. 4, 5B, and 5C. The wireless communication device 800 may include a receiver 810, a communications manager 815, a beam management component 830, a beam tracking report component 840, and a transmitter 820, which may be in communication with one another (for example, via one or more buses). In some examples, the wireless communication device 800 is configured to perform operations, including operations of the process 900 described below with reference to FIG. 9.

In some examples, the wireless communication device 800 can include a chip, system on chip (SOC), chipset, package, or device that includes at least one processor and at least one modem (for example, a 5G modem or other cellular modem). In some examples, the communications manager 815, or its sub-components, may be separate and distinct components. In some examples, at least some components of the communications manager 815 are implemented at least in part as software stored in a memory. For example, portions of one or more of the components of the communications manager 815 can be implemented as non-transitory code executable by the processor to perform the functions or operations of the respective component.

The receiver 810 may receive one or more reference signals (for example, periodically configured CSI-RSs, aperiodically configured CSI-RSs, or multi-beam-specific reference signals), synchronization signals (for example, synchronization signal blocks (SSBs)), control information, or data information, such as in the form of packets, from one or more other wireless communication devices via various channels including control channels (for example, a PUCCH or a PSCCH) and data channels (for example, a PUSCH or a PSSCH). The other wireless communication devices may include, but are not limited to, a UE 120, described with reference to FIGS. 1, 2, and 3, or a wireless communication device 402 described with reference to FIGS. 4, 5B, and 5C.

The received information may be passed on to other components of the wireless communication device 800. The receiver 810 may be an example of aspects of the receive processor 238 described with reference to FIG. 2. The receiver 810 may include a set of radio frequency (RF) chains that are coupled with or otherwise utilize a set of antennas (for example, the set of antennas may be an example of aspects of the antennas 234 described with reference to FIG. 2).

The transmitter 820 may transmit signals generated by the communications manager 815 or other components of the wireless communication device 800. In some examples, the transmitter 820 may be collocated with the receiver 810 in a transceiver. The transmitter 820 may be an example of aspects of the transmit processor 220 described with reference to FIG. 2. The transmitter 820 may be coupled with or otherwise utilize a set of antennas (for example, the set of antennas may be an example of aspects of the antennas 234), which may be antenna elements shared with the receiver 810. In some examples, the transmitter 820 is configured to transmit control information in a PDCCH or a PSCCH and data in a PDSCH or PSSCH.

The communications manager 815 may be an example of aspects of the controller/processor 240 described with reference to FIG. 2. The communications manager 815 includes the beam management component 830 and the beam tracking report component 840. In some examples, working in conjunction with the transmitter 820, the beam management component 830 transmits, to a wireless communication device including a group of reflector devices, a first beam associated with a first beam direction. Additionally, working in conjunction with the receiver 810, the beam tracking report component 840 receives, from one reflector device of the group of reflector devices based on transmitting the first beam, a first message including a first beam tracking report that includes one or more first parameters associated with a second beam direction corresponding to a predicted position of the wireless communication device at a future time based on a motion and a speed of the wireless communication device. Finally, working in conjunction with one or more of the transmitter 820 or the beam tracking report component 840, the beam management component 830 transmits, to the wireless communication device, a second beam based on the one or more first parameters. The second beam may be associated with the second beam direction.

FIG. 9 is a flow diagram illustrating an example process 900 performed by a network node 400, in accordance with some aspects of the present disclosure. The example process 900 is an example of a beam management process. As shown in FIG. 9, the process 900 begins at block 902 by transmitting, to a wireless communication device including a group of reflector devices, a first beam associated with a first beam direction. At block 904, the process 900 receives, from one reflector device of the group of reflector devices based on transmitting the first beam, a first message including a first beam tracking report that includes one or more first parameters associated with a second beam direction corresponding to a predicted position of the wireless communication device at a future time based on a motion and a speed of the wireless communication device. At block 906, the process 900 transmits, to the wireless communication device, a second beam associated with the second beam direction based on the one or more first parameters.

Implementation examples are described in the following numbered clauses:

Clause 1. A method for wireless communication at a wireless communication device, comprising: receiving, from a network node at a reflector device of a group of reflector devices associated with the wireless communication device, a first beam associated with a first beam direction; transmitting, to the network node via the reflector device based on receiving the first beam, a first message including a first beam tracking report that includes one or more first parameters associated with a second beam direction corresponding to a predicted position of the wireless communication device at a future time based on tracking motion of the wireless communication device; and receiving, from the network node, a second beam based on the one or more first parameters.

Clause 2. The method of Clause 1, further comprising estimating a direction of motion of the wireless communication device based on one or both of an energy measurement of the first beam by one or more reflector devices of the group of reflector devices or a movement measurement by one or more sensors associated with the wireless communication device, wherein the second beam direction is based on estimating the direction of movement of the wireless communication device.

Clause 3. The method of Clause 2, wherein the direction of motion is estimated according to six degrees of freedom.

Clause 4. The method of Clause 2, wherein the one or more first parameters indicate one of: a difference between the first beam direction and the second beam direction; or an absolute value corresponding to an adjustment to the first beam direction.

Clause 5. The method of Clause 2, wherein the one or more first parameters indicate the direction of movement.

Clause 6. The method of any one of Clauses 1-5, wherein: the one or more first parameters indicate an altitude and an azimuth associated with the second beam direction; and the altitude and the azimuth correspond to respective axes in a coordinate system.

Clause 7. The method of any one of Clauses 1-5, further comprising transmitting a second message, based on receiving the first beam, including a second beam tracking report that includes one or more second parameters associated with the second beam direction, wherein: the one or more first parameters indicate an altitude associated with the second beam direction; and the one or more second parameters indicate an azimuth associated with the second beam direction.

Clause 8. The method of any one of Clauses 1-7, wherein the one or more first parameters indicate a time for receiving the second beam.

Clause 9. The method of any one of Clauses 1-8, wherein: the first message is transmitted on a CDMA waveform or a SC waveform; and the first message is modulated based on on-off keying or pulse amplitude modulation.

Clause 10. The method of any one of Clauses 1-8, further comprising modulating a downlink payload included in the first beam, wherein the first message is the modulated downlink payload.

Clause 11. The method of any one of Clauses 1-10, wherein each reflector device of the group of reflector devices is a MRR or a smart repeater of a RIS.

Clause 12. The method of any one of Clauses 1-11, wherein: the wireless communication device is an OWC device; the first beam is a first OWC beam; and the second beam is a second OWC beam.

Clause 13. A method for wireless communication at a network node, comprising: transmitting, to a wireless communication device including a group of reflector devices, a first beam associated with a first beam direction; receiving, from one reflector device of the group of reflector devices based on transmitting the first beam, a first message including a first beam tracking report that includes one or more first parameters associated with a second beam direction corresponding to a predicted position of the wireless communication device at a future time based on a motion and a speed of the wireless communication device; and transmitting, to the wireless communication device, a second beam associated with the second beam direction based on the one or more first parameters.

Clause 14. The method of Clause 13, wherein the one or more first parameters indicate one of: a difference between the first beam direction and the second beam direction; or an absolute value corresponding to an adjustment to the first beam direction.

Clause 15. The method of any one of Clauses 13-14, wherein the one or more first parameters indicate a direction of movement of the wireless communication device.

Clause 16. The method of any one of Clauses 13-15, wherein: the one or more first parameters indicate an altitude and an azimuth associated with the second beam direction; and the altitude and the azimuth correspond to respective axes in a coordinate system.

Clause 17. The method of any one of Clauses 13-15, further comprising receiving a second message, based on transmitting the first beam, including a second beam tracking report that includes one or more second parameters associated with the second beam direction, wherein: the one or more first parameters indicate an altitude associated with the second beam direction; and the one or more second parameters indicate an azimuth associated with the second beam direction.

Clause 18. The method of any one of Clauses 13-17, wherein the one or more first parameters indicate a time for receiving the second beam in the second beam direction.

Clause 19. The method of any one of Clauses 13-18, wherein: the first message is received on a CDMA waveform or a SC waveform; and the first message is modulated based on on-off keying or pulse amplitude modulation.

Clause 20. The method of any one of Clauses 13-18, wherein: the first beam includes a downlink payload included in the first beam; and the first message is a modulation of the downlink payload.

Clause 21. The method of any one of Clauses 13-20, wherein each reflector device of the group of reflector devices is a MRR or a smart repeater of a RIS.

The foregoing disclosure provides illustration and description, but is not intended to be exhaustive or to limit the aspects to the precise form disclosed. Modifications and variations may be made in light of the above disclosure or may be acquired from practice of the aspects.

As used, the term “component” is intended to be broadly construed as hardware, firmware, or a combination of hardware and software. As used, a processor is implemented in hardware, firmware, or a combination of hardware and software.

Some aspects are described in connection with thresholds. As used, satisfying a threshold may, depending on the context, refer to a value being greater than the threshold, greater than or equal to the threshold, less than the threshold, less than or equal to the threshold, equal to the threshold, not equal to the threshold, or the like.

It will be apparent that systems or methods described may be implemented in different forms of hardware, firmware, or a combination of hardware and software. The actual specialized control hardware or software code used to implement these systems or methods is not limiting of the aspects. Thus, the operation and behavior of the systems or methods were described without reference to specific software code-it being understood that software and hardware can be designed to implement the systems or methods based, at least in part, on the description.

Even though particular combinations of features are recited in the claims or disclosed in the specification, these combinations are not intended to limit the disclosure of various aspects. In fact, many of these features may be combined in ways not specifically recited in the claims or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (for example, a-a, a-a-a, a-a-b, a-a-c, a-b-b, a-c-c, b-b, b-b-b, b-b-c, c-c, and c-c-c or any other ordering of a, b, and c).

No element, act, or instruction used should be construed as critical or essential unless explicitly described as such. Also, as used, the articles “a” and “an” are intended to include one or more items, and may be used interchangeably with “one or more.” Furthermore, as used, the terms “set” and “group” are intended to include one or more items (for example, related items, unrelated items, a combination of related and unrelated items, or the like), and may be used interchangeably with “one or more.” Where only one item is intended, the phrase “only one” or similar language is used. Also, as used, the terms “has,” “have,” “having,” or the like are intended to be open-ended terms. Further, the phrase “based on” is intended to mean “based, at least in part, on” unless explicitly stated otherwise.

1. A method for wireless communication at a wireless communication device, comprising:
receiving, from a network node at a reflector device of a group of reflector devices associated with the wireless communication device, a first beam associated with a first beam direction;
transmitting, to the network node via the reflector device based on receiving the first beam, a first message including a first beam tracking report that includes one or more first parameters associated with a second beam direction corresponding to a predicted position of the wireless communication device at a future time based on tracking motion of the wireless communication device; and
receiving, from the network node, a second beam based on the one or more first parameters.

2. The method of claim 1, further comprising estimating a direction of motion of the wireless communication device based on one or both of an energy measurement of the first beam by one or more reflector devices of the group of reflector devices or a movement measurement by one or more sensors associated with the wireless communication device, wherein the second beam direction is based on estimating the direction of movement of the wireless communication device.

3. The method of claim 2, wherein the direction of motion is estimated according to six degrees of freedom.

4. The method of claim 2, wherein the one or more first parameters indicate one of:
a difference between the first beam direction and the second beam direction; or
an absolute value corresponding to an adjustment to the first beam direction.

5. The method of claim 2, wherein the one or more first parameters indicate the direction of movement.

6. The method of claim 1, wherein:
the one or more first parameters indicate an altitude and an azimuth associated with the second beam direction; and
the altitude and the azimuth correspond to respective axes in a coordinate system.

7. The method of claim 1, further comprising transmitting a second message, based on receiving the first beam, including a second beam tracking report that includes one or more second parameters associated with the second beam direction, wherein:
the one or more first parameters indicate an altitude associated with the second beam direction; and
the one or more second parameters indicate an azimuth associated with the second beam direction.

8. The method of claim 1, wherein the one or more first parameters indicate a time for receiving the second beam.

9. The method of claim 1, wherein:
the first message is transmitted on a code division multiple access (CDMA) waveform or a single carrier (SC) waveform; and
the first message is modulated based on on-off keying or pulse amplitude modulation.

10. The method of claim 1, further comprising modulating a downlink payload included in the first beam, wherein the first message is the modulated downlink payload.

11. The method of claim 1, wherein each reflector device of the group of reflector devices is a modulated retro reflector (MRR) or a smart repeater.

12. The method of claim 1, wherein:
the wireless communication device is an optical wireless communication (OWC) device;
the first beam is a first OWC beam; and
the second beam is a second OWC beam.

13. An apparatus for wireless communications at a wireless communication device, comprising:
a processor; and
a memory coupled with the processor and storing instructions operable, when executed by the processor, to cause the apparatus to:
receive, from a network node at a reflector device of a group of reflector devices associated with the wireless communication device, a first beam associated with a first beam direction;
transmit, to the network node via the reflector device based on receiving the first beam, a first message including a first beam tracking report that includes one or more first parameters associated with a second beam direction corresponding to a predicted position of the wireless communication device at a future time based on tracking a motion and a speed of the wireless communication device; and
receive, from the network node, a second beam based on the one or more first parameters.

14. The apparatus of claim 13, wherein execution of the instructions further cause the apparatus to estimate a direction of motion of the wireless communication device based on one or both of an energy measurement of the first beam by one or more reflector devices of the group of reflector devices or a movement measurement by one or more sensors associated with the wireless communication device, wherein the second beam direction is based on estimating the direction of movement of the wireless communication device.

15. The apparatus of claim 14, wherein the direction of motion is estimated according to six degrees of freedom.

16. The apparatus of claim 14, wherein the one or more first parameters indicate one of:
a difference between the first beam direction and the second beam direction; or
an absolute value corresponding to an adjustment to the first beam direction.

17. The apparatus of claim 14, wherein the one or more first parameters indicate the direction of movement.

18. The apparatus of claim 13, wherein each reflector device of the group of reflector devices is a modulated retro reflector (MRR) or a smart repeater.

19. A method for wireless communication at a network node, comprising:
transmitting, to a wireless communication device including a group of reflector devices, a first beam associated with a first beam direction;
receiving, from one reflector device of the group of reflector devices based on transmitting the first beam, a first message including a first beam tracking report that includes one or more first parameters associated with a second beam direction corresponding to a predicted position of the wireless communication device at a future time based on a motion and a speed of the wireless communication device; and
transmitting, to the wireless communication device, a second beam based on the one or more first parameters.

20. The method of claim 19, wherein the one or more first parameters indicate one of:
a difference between the first beam direction and the second beam direction;
an absolute value corresponding to an adjustment to the first beam direction;
a direction of movement of the wireless communication device; or
an altitude and an azimuth associated with the second beam direction, the altitude and the azimuth corresponding to respective axes in a coordinate system.

21-30. (canceled)
